(19) United States
(12) Patent Application Publication
(10) Pub. No.: US 2016/0236626 A1
(43) Pub. Date: Aug. 18, 2016

(54) System and Method for Mounting a Cell Phone or Similar Item in a Vehicle

(71) Applicant: Constantine George Yialamas, Nazareth, PA (US)

(72) Inventor: Constantine George Yialamas, Nazareth, PA (US)

(21) Appl. No.: 14/622,825

(22) Filed: Feb. 13, 2015

(51) Int. Cl. B60R 11/02; B60R 1/04

(52) U.S. Cl. CPC B60R 11/02; B60R 1/04; B60R 2011/0033

(57) ABSTRACT

A mounting system that is used to mount a handheld electronic device, such as a smart phone, to the rearview mirror assembly of a vehicle or similar mounting point. A hanger is provided. The hanger has a mounting structure that engages the rearview mirror assembly and enables the hanger to hang suspended under the rearview mirror assembly. The hanger supports at least one magnet. A metal plate is affixed to the handheld electronic device or to any protective case that surrounds the handheld electronic device. When the handheld electronic device is brought into close proximity of the hanger, the magnet attracts to the metal plate and creates a magnetic connection. The magnetic connection attaches the handheld electronic device to the hanger under the rearview mirror assembly.

### BACKGROUND OF THE INVENTION

1. Field of the Invention

In general, the present invention relates to systems and methods used to mount cell phones and other handheld electronic devices in a vehicle. More particularly, the present invention relates to systems and methods that retain the cell phone or similar device in a fixed position using a magnetic connection.

2. Prior Art Description

Many people use cell phones or other handheld electronic devices as they drive. For instance, many people utilize their cell phone as a GPS guidance system. Still other people use their cell phones as MP3 music players. Many people simply use their cell phones as phones. Regardless of its intended use, a driver of a vehicle often has need to mount his/her cell phone within the confines of the car in a position that can be readily seen and accessed by the driver.

The prior art is replete with mounting devices that are intended to hold a handheld electronic device in a vehicle. Many of these mounts include a base that is adhesively mounted to the dashboard of the vehicle. The mount is adapted to receive a cell phone or similar device with a clamp or magnet. Such prior art is exemplified by U.S. Pat. No. 5,992,807 to Tarulli, entitled Universal Magnet Stand For Cell Phones.

The primary problem with such prior art mounting systems is that the base of the mounting system is stuck to the surface of the vehicle dashboard with adhesive. This can cause damage to the dashboard of the vehicle. Furthermore, it prevents the mounting system from being easily removed from one vehicle and placed into another.

Other prior art system utilize suction cup mounts that attach directly to the glass of the windshield in a vehicle. Such mounts inevitably lose suction and disconnect from the windshield. This often happens while the vehicle is in motion and the driver must concentrate on driving. The fall from the windshield can damage the electronic device that was supported. Furthermore, the fall of the electronic device can distract the driver and/or create an obstacle at the driver's feet. In either case, a driving hazard is created. Furthermore, suction cup mounts leave telltale rings on the windshield that inform thieves of the potential presence of a valuable GPS or cell phone inside the vehicle.

Mounting systems also exist that can attach various items to the rearview mirror of a vehicle. Such prior art is exemplified by U.S. Pat. No. 7,695,148 to Davis, entitled Rear View Mirror GPS Holder and U.S. Pat. No. 8,220,188 to Keller, entitled Device For Connecting A Placecard To The Rearview Mirror Of A Motor Vehicle And Method Of Use. The problem with such systems is that they are not designed to hold relatively heavy objects, such as a modern smart phone. Furthermore, such prior art mounting systems hold phones in pockets or trays where the screen of the cell phone is partially obscured and the controls of the phone are difficult to access while driving.

A need therefore exists for a system and method of mounting a cell phone or other handheld electronic device to a rearview mirror in a manner that avoids the inherent problems of the prior art. This need is met by the present invention as described and claimed below.

### SUMMARY OF THE INVENTION

The present invention is a mounting system that is used to mount a handheld electronic device, such as a smart phone, to the rearview mirror assembly of a vehicle or similar mounting point. A hanger is provided. The hanger has a mounting structure that engages the rearview mirror assembly and enables the hanger to hang suspended under the rearview mirror assembly. The hanger supports at least one magnet.

A metal plate is affixed to the handheld electronic device or to any protective case that surrounds the handheld electronic device. When the handheld electronic device is brought into close proximity of the hanger, the magnet attracts to the metal plate and creates a magnetic connection. The magnetic connection attaches the handheld electronic device to the hanger under the rearview mirror assembly.

### BRIEF DESCRIPTION OF THE DRAWINGS

For a better understanding of the present invention, reference is made to the following description of the exemplary embodiments thereof, considered in conjunction with the accompanying drawings, in which:

FIG. 1 is an exploded perspective view of an exemplary embodiment of mounting system shown in conjunction with a rearview mirror assembly and a handheld electronic device;

FIG. 2 is a front view of the mounting system of FIG. 1;

FIG. 3 is perspective view of a first alternative embodiment of the present invention; and

FIG. 4 is a perspective view of a second alternative embodiment of the present invention.

### DETAILED DESCRIPTION OF THE DRAWINGS

Although the present invention mounting system can be embodied in many ways, only a few embodiments are illustrated. The embodiments are selected for the purposes of description and explanation and present the best modes contemplated for the invention. The illustrated embodiments, however, are merely exemplary and should not be considered limitations when interpreting the scope of the appended claims.

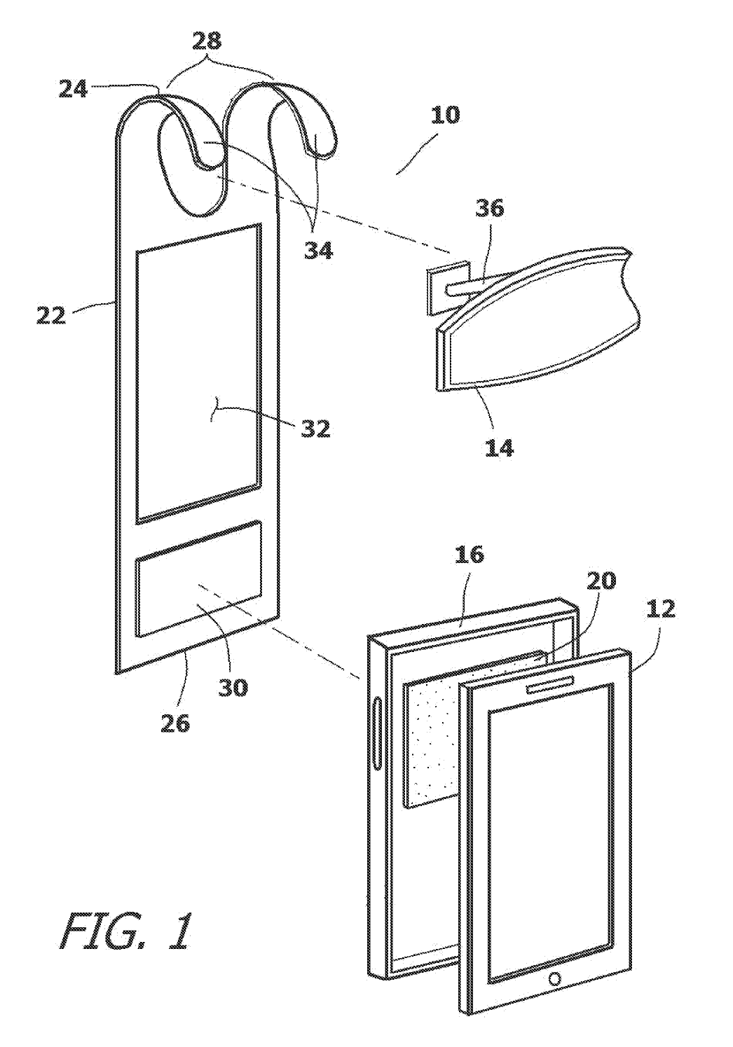

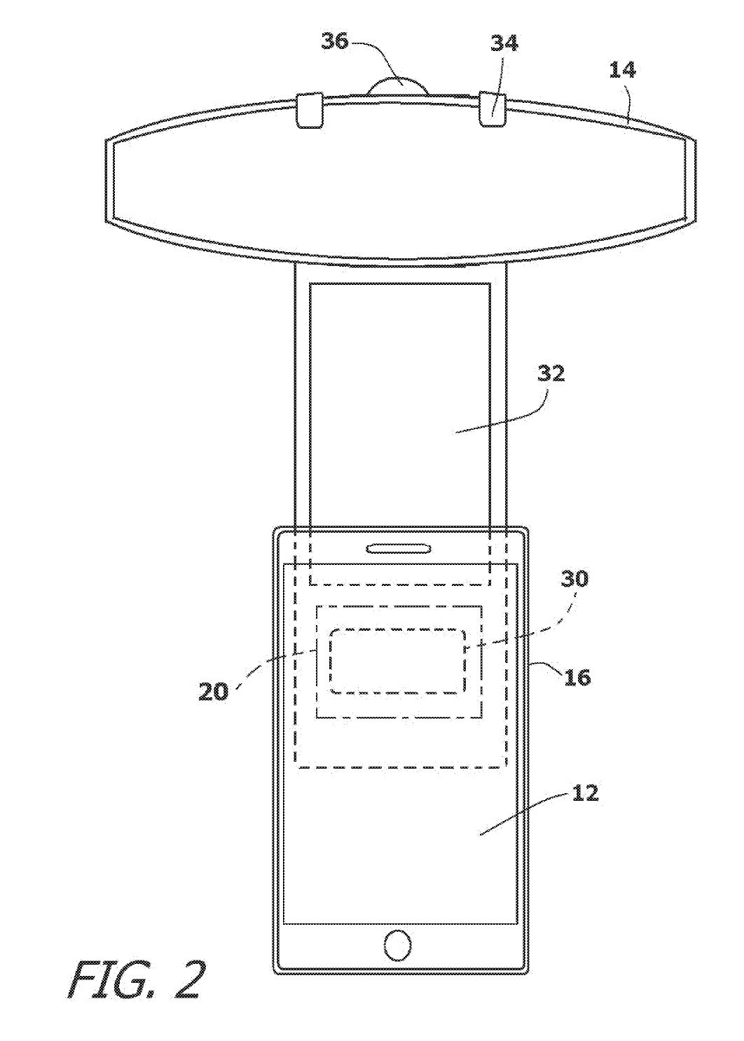

Referring to FIG. 1, in conjunction with FIG. 2, a mounting system 10 is shown that is used to mount a handheld electronic device 12 to a rearview mirror assembly 14 in a vehicle. In the shown embodiment, the handheld electronic device 12 is configured as a cell phone. However, the handheld electronic device 12 can be a GPS unit, a small tablet computer, an MP3 player or the like. Furthermore, in the shown embodiment, the handheld electronic display 12 is held in a protective case 16 that covers the back and sides of the handheld electronic device 12. The use of a protective case 16 is not required, as will later be explained. The protective case 16 is shown merely because many people carry their cell phones in such protective cases.

A ferro-magnetic plate 20, such as a section of steel sheet metal, is provided. The plate 20 preferably has rounded edges, so as not to scratch or cut any object it rubs against. The plate 20 is interposed between the handheld electronic device 12 and its protective case 16. Depending upon the snugness of the protective case 16, or lack thereof, the plate 20 can be set into a fixed position with adhesive. If a person does not use a protective case 16 on his/her handheld electronic device 12, the plate 20 can be adhesively affixed to the back of the handheld electronic device 12. Similarly, if a person uses a protective case 16 with tolerances that prevent the plate 20 from being placed under the protective case 16, then the plate 20 can be adhesively affixed to the exterior of the protective case 16. It will further be understood that specialized protective cases can be made where the plate 20 is integrated into the structure of the protective case 16.

A hanger 22 is provided. The hanger 22 has a top first end 24 and a bottom second end 26. A mounting structure 28 is formed in the hanger 22, proximate its first end 24. The mounting structure 28 enables the hanger 22 to engage the rearview mirror assembly 14 within a vehicle. Once engaged with the rearview mirror assembly 14, the hanger 22 hangs from the rearview mirror assembly 14 so that the second end 26 of the hanger 22 is suspended below the rearview mirror assembly 14.

A magnet 30 is anchored to the hanger 22 proximate the second end 26 of the hanger 22. The magnet 30 is strong enough to attach and retain the plate 20 that is inside the protective case 16 of the handheld electronic device 12. Accordingly, when the handheld electronic device 12 is brought into close proximity of the hanger 22, the magnet 30 on the hanger 22 attracts the plate 20 behind or inside the protective case 16. This attaches the handheld electronic device 12 to the hanger 22. The magnetic attachment is strong enough to support the full weight of the handheld electronic device 12.

As is shown in FIG. 2, the handheld electronic device 12 is suspended from the rearview mirror assembly 14 by the hanger 22. The handheld electronic device 12 is attached to the hanger 22 only by a magnetic connection. As such, the handheld electronic device 12 can be easily detached from the hanger 22 by merely pulling or sliding the handheld electronic device 12 away from the hanger 22. Once detached, the handheld electronic device 12 can be readily reattached to the hanger 22 by simply bringing it into close contact with the hanger 22. Once close to the hanger 22, the magnet 30 will automatically attach to the protective case 16 of the handheld electronic device 12 atop the ferro-magnetic plate 20.

Many vehicles have a rearview mirror assembly 14 that is mounted high on the windshield so as not to be an impediment to viewing the road. The hanger 22 is elongated so as to support the handheld electronic device 12 below the primary line of sight. Furthermore, a window 32 is formed through the hanger 22. The window greatly reduces the area of the windshield that is obstructed by the hanger 22. As such, the driver can see through the window 32 and observe the road behind the hanger 22.

The hanger 22 is preferably made of plastic or cut from laminations of plastic. As such, the hanger 22 is lightweight, flexible, and inexpensive to produce. The mounting structure 28 at the first end 24 of the hanger 22 can have many forms. In the shown embodiment, the mounting structure 28 has two hook elements 34 that pass over the rearview mirror assembly 14 on either side of the support neck 36 for the rearview mirror assembly 14. The use of two hook elements 34 in such a configuration helps inhibit the hanger 22 from swaying in the vehicle as the vehicle moves and turns.

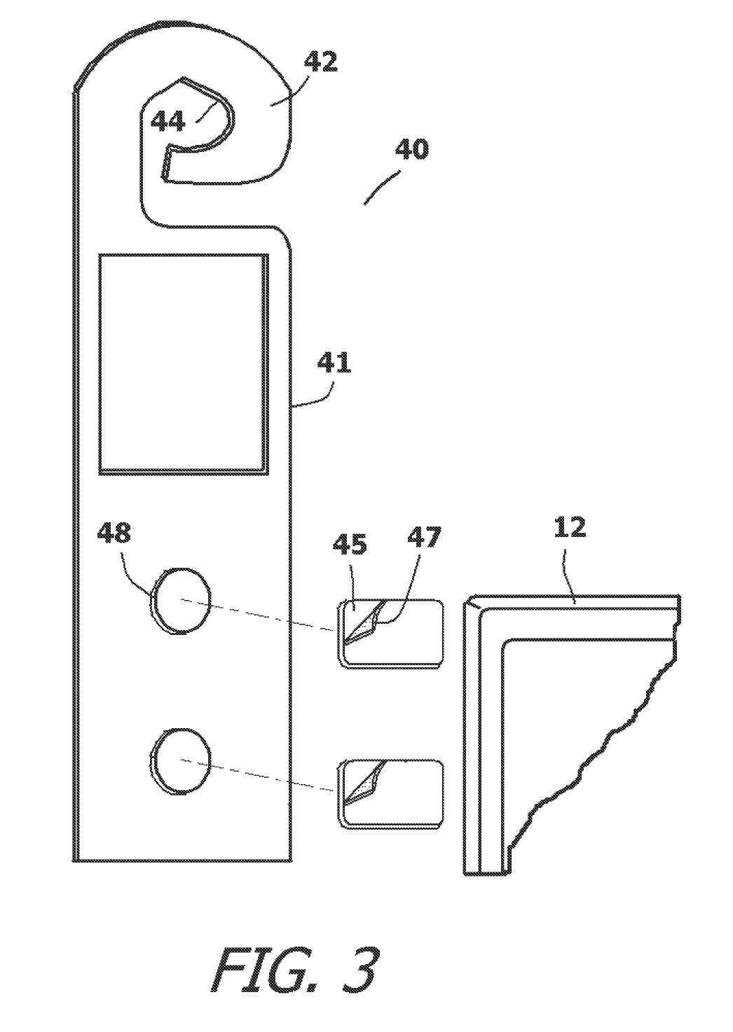

Referring to FIG. 3, an alternate embodiment of the mounting system 40 is shown. In this embodiment, the hanger 41 is provided with a hangtag loop 42 at its first end. The hangtag loop 42 passes around the support neck of the rearview mirror assembly. The hangtag loop 42 can have flat edges 44 to inhibit the swaying of the hanger 41. A plurality of smaller magnets 48 are anchored to the hanger 41 at various points.

Ferro-magnetic plates 45 are provided that have peel-away adhesive backings 47. The plates 45 are attached to the rear of the handheld electronic device 12 or any protective case that covers the handheld electronic device 12. The handheld electronic device 12 is placed against the hanger 41, where it is engaged by the magnets 48. Since multiple magnets 48 are being used, smaller, less expensive magnets 48 can be used. Likewise, smaller metal plates 45 can be affixed to the handheld electronic device 12 or any protective case 16 that shields the handheld electronic device 12. This will avoid any problems that may be caused in signal reception by a larger metal plate. The smaller metal plates 45 also provide more versatility to mount around features of the handheld electronic device, such as rearwardly facing camera lenses.

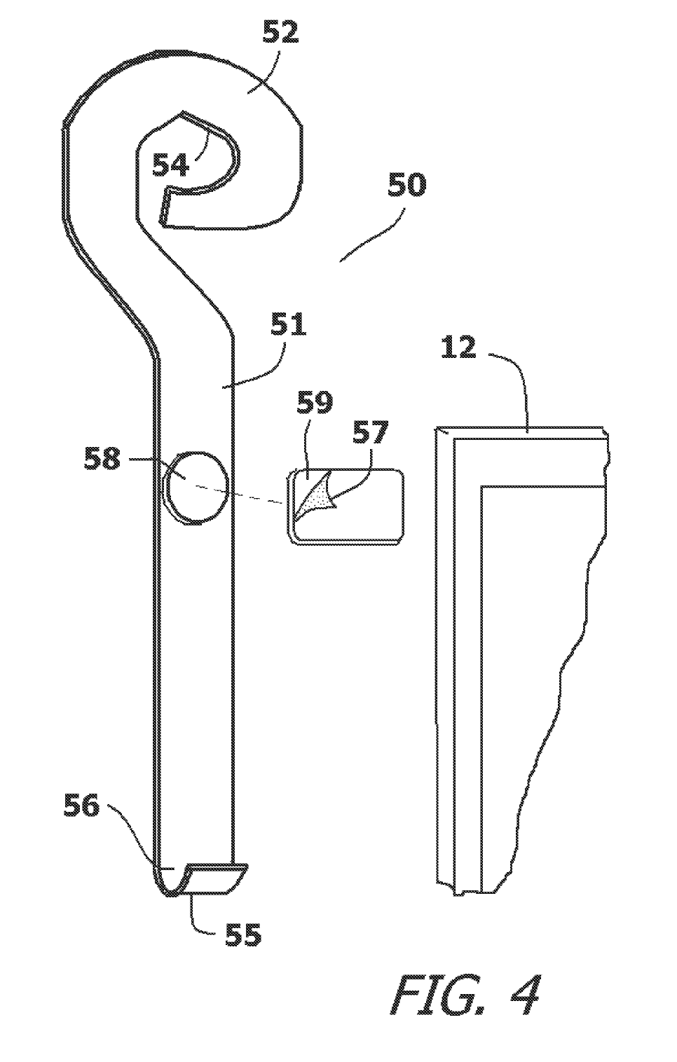

Referring now to FIG. 4, another embodiment of the mounting system 50 is shown. This embodiment is the smallest and the least expensive to manufacture. In this embodiment, the hanger 51 is provided with a hangtag loop 52 at its first end. The hangtag loop 52 passes around the support neck of the rearview mirror assembly. The hangtag loop 52 can have flat edges 54 to inhibit the swaying of the hanger 51. In this embodiment, the bottom second end 55 of the hanger 51 is curved. This forms a small protruding ledge 56. A small magnet 58 is anchored to the hanger 51 at some point above the ledge 56.

A ferro-magnetic plate 59 is provided with a peel-away adhesive backing 57. The plate 59 is attached to the handheld electronic device 12. The handheld electronic device 12 is placed against the hanger 51 and rests upon the small protruding ledge 56. The small protruding ledge 56 supports most of the weight of the handheld electronic device 12. Accordingly, the magnet 58 need only be strong enough to prevent the handheld electronic device 12 from falling away from the hanger 51. The magnet 58 need not be strong enough to support the full weight of the handheld electronic device 12. Consequently, a small, inexpensive magnet 58 can be used. Likewise, a smaller metal plate 59 can be affixed to the handheld electronic device 12 or any protective case that shields the handheld electronic device 12.

It will be understood that the embodiments of the present invention that are illustrated and described are merely exemplary and that a person skilled in the art can make many variations to those embodiments. Furthermore, features from the different embodiments can be mixed and matched in other embodiments. For instance, the curved ledge in the embodiment of FIG. 4 can be added to the embodiments of FIG. 1 or FIG. 2. All such embodiments are intended to be included within the scope of the present invention as defined by the claims.

What is claimed is:

1. A mounting system, comprising:
a rearview mirror assembly disposed in a vehicle;
a handheld electronic device;
a metal plate supported by said handheld electronic device;
a hanger having a first end and an opposite second end, wherein a mounting structure is disposed at said first end that selectively connects to the rearview mirror assembly; and
at least one magnet supported by said hanger, wherein said at least one magnet magnetically attracts said metal plate when said at least one magnet is proximate said metal plate, therein magnetically connecting said metal plate to said hanger.

2. The system according to claim 1, further including an open window formed through said hanger between said at least one magnet and said mounting structure.

3. The system according to claim 1, wherein said mounting structure includes at least one hook element that mechanically engages said rear view mirror assembly.

4. The system according to claim 1, wherein said rearview mirror assembly has a support neck and said mounting structure engages said support neck.

5. The system according to claim 4, wherein said mounting structure includes a hangtag loop.

6. The system according to claim 1, further including a ledge protruding from said hanger proximate said second end, wherein said handheld electronic device rests upon said ledge.

7. The system according to claim 1, wherein said handheld electronic device is encased in a protective casing and said metal plate is interposed between said handheld electronic device and said protective casing.

8. The system according to claim 1, wherein said metal plate is affixed to said handheld electronic device with adhesive.

9. A mounting system for mounting a handheld electronic device to a rearview mirror assembly within a vehicle, said system comprising;
a hanger having a first end and an opposite second end, wherein said first end is formed into a mounting structure that is adapted to selectively engage the rearview mirror assembly;
at least one magnet supported by said hanger;
a metal plate having adhesive thereon that attaches to the handheld electronic device, wherein said at least one magnet magnetically attracts said metal plate when said magnet is proximate said metal plate, therein magnetically connecting said metal plate to said hanger.

10. The system according to claim 9, further including an open window formed through said hanger between said at least one magnet and said mounting structure.

11. The system according to claim 9, wherein said mounting structure includes at least one hook element that can mechanically engage said rearview mirror assembly.

12. The system according to claim 9, wherein said mounting structure includes a hangtag loop.

13. The system according to claim 9, further including a ledge protruding from said hanger proximate said second end.

14. A method of mounting a handheld electronic device to a rearview mirror assembly in a vehicle, said method comprising the steps of:
attaching a metal plate to said handheld electronic device;
providing a hanger having a first end and an opposite second end, wherein at least one magnet is supported by said hanger proximate said second end;
hanging said hanger from said rearview mirror assembly; and
connecting said handheld electronic device to said hanger with a magnetic connection by bringing said metal plate proximate said at least one magnet.

15. The method according to claim 14, wherein said step of providing a hanger includes providing a hanger with an open window formed through said hanger.

16. The method according to claim 14, wherein said step of hanging said hanger from said rearview mirror assembly includes hooking said hanger onto said rearview mirror assembly.

17. The method according to claim 14, wherein said step of attaching a metal plate to said handheld electronic device includes attaching said metal plate directly to said handheld electronic device.

18. The method according to claim 14, wherein said step of attaching a metal plate to said handheld electronic device includes attaching said metal plate to a protective casing around said handheld electronic device.

19. The method according to claim 14, wherein said step of attaching a metal plate to said handheld electronic device includes interposing said metal plate between said handheld electronic device and a protective casing that surrounds said handheld electronic device.
